(19) United States
(12) Patent Application Publication
(10) Pub. No.: US 2017/0016122 A1
(43) Pub. Date: Jan. 19, 2017

(54) COATING METHOD AND COMPONENT

(71) Applicant: Siemens Aktiengesellschaft, München (DE)

(72) Inventor: Ingo Reinkensmeier, Fröndenberg (DE)

(73) Assignee: Siemens Aktiengesellschaft, München (DE)

(21) Appl. No.: 15/124,068

(22) PCT Filed: Mar. 4, 2015
(86) PCT No.: PCT/EP2015/054481

§ 371 Date: Sep. 7, 2016

(30) Foreign Application Priority Data
Mar. 24, 2014 (EP) 10 2014 205 413.3

(51) Int. Cl. C23C 24/10; B23K 35/32; C22C 14/00; F01D 5/28; C23C 28/02; B23K 35/02; B32B 15/01; B23K 1/00; C23C 8/10

(52) U.S. Cl. CPC C23C 24/106; B23K 1/0018; B23K 35/325; C22C 14/00; C23C 8/10; C23C 28/021; B23K 35/0244; B32B 15/017; F01D 5/288; B23K 2201/001

(57) ABSTRACT

A coating method for applying a cover layer to a base material is provided. A solder positioned on a surface of the base material is heated until it is molten, for joining the solder to the base material in a heat treatment. Oxygen is diffused in the molten lot for forming a diffusion layer in the cover layer. A component for a steam turbine is also provided.

### CROSS-REFERENCE TO RELATED APPLICATIONS

This application claims priority to PCT Application No. PCT/EP2015/054481, having a filing date of Mar. 4, 2015, based off of German application No. DE 102014205413.3 having a filing date of Mar. 24, 2014, the entire contents of which are hereby incorporated by reference.

### FIELD OF TECHNOLOGY

The following invention relates to a coating process for applying a covering layer to a base material and also a component for a steam turbine.

### BACKGROUND

Various techniques for improving the wear resistance of, in particular, blades of a steam turbine are known in the prior art. One of them is application of a wear-resistant layer comprising hard materials to the base material. For example, this can be effected by thermal spraying.

In addition, it is known that outer layer hardening of titanium and titanium alloys can be achieved by allowing oxygen to diffuse into the surface.

US 2006099435 A1 discloses a process for case hardening and object composed of titanium or a titanium-based alloy or of zirconium or a zirconium alloy. Here, the object is heat treated at one or more temperatures in the range from 850° C. to 900° C. and at a pressure in the region of atmospheric pressure in an oxygen diffusion atmosphere comprising (a) a carrier gas which does not react chemically with the object in the temperature range indicated and (b) molecular oxygen, where the concentration of oxygen in the oxygen diffusion atmosphere is in the range from 100 parts per million by volume to 400 parts per million by volume.

US 2010252146 A1 discloses a process for producing an intermetallic titanium-aluminum alloy having improved hardness and wear resistance. The process comprises formation of an oxygen diffusion layer which acts as wear-resistant working surface on the surface of the intermetallic titanium-aluminum alloy. The oxygen diffusion layer has the effect of increasing the surface hardness, reducing the coefficient of friction and reducing the wear rate or increasing the wear resistance of the intermetallic alloy compared to the intermetallic alloy without an oxygen diffusion layer.

### SUMMARY

An aspect relates to providing an improved coating process and a component having improved wear resistance.

In the coating process of embodiments of the invention, a covering layer is applied to a base material by heating a solder positioned on a surface of the base material in a heat treatment until it is molten in order to join the solder to the base material. According to embodiments of the invention, oxygen is diffused into the molten solder in order to form a diffusion layer in the covering layer.

According to embodiments of the invention, a soldering process is thus combined with an oxygen diffusion process. The covering layer gains, at the same time as the soldering process, a diffusion layer which increases the wear resistance of the covering layer, in particular against abrasive wear.

Carrying out the diffusion process while the solder is in a liquid state considerably simplifies the diffusion of oxygen into the solder. The diffusion time over which the diffusion layer is formed can therefore be shorter than in conventional diffusion processes. In particular, a diffusion time of 30 minutes is sufficient, compared to conventional diffusion times of a number of hours.

In addition, the diffusion layer into which the oxygen becomes embedded in atomic form can be made significantly larger. Thus, penetration depths and thus thicknesses of the diffusion layer of from 40 μm to 80 μm are achieved by means of conventional processes, while the coating process of embodiments of the invention makes a thickness of the diffusion layer of up to 2 mm possible. The wear resistance can thereby be increased further.

Furthermore, the coating process of embodiments of the invention provides a process which is suitable not only for coating for the first time but also for repair of an existing, damaged covering layer. Components of gas turbines in particular can be provided with a covering layer by the coating process of embodiments of the invention, or the covering layer of such components can be repaired by means of the coating process of embodiments of the invention.

In an advantageous embodiment of the coating process of the invention, a titanium alloy, in particular TiA16V4, is used as base material. For this purpose, a titanium-based solder, in particular, is then used as solder, especially Ti braze.

The coating process of embodiments of the invention is particularly suitable for titanium alloys since titanium alloys have not only high strengths combined with low densities but also high notch sensitivity and a short critical crack length. The notch sensitivity and the critical crack length can be significantly improved by means of the present process.

In an advantageous embodiment of the coating process of embodiments of the invention, the solder is mixed with a base material which consists of the same material as the base material. It has been found to be advantageous for the base material to be present in the solder in a proportion by mass of from 30% to 70%.

In this way, the properties of the covering layer to be produced are positively influenced.

In a further advantageous embodiment of the coating process of the invention, the solder is used in powder form. In particular, a ribbon in which the pulverulent solder has been applied to a support layer is used.

In this way, the solder can be positioned more simply and more accurately on the base material. The ribbon ensures uniform distribution and a constant thickness of the layer of solder.

The component according to embodiments of the invention for a steam turbine comprises a base material and a covering layer affixed to a surface of the base material. The covering layer has, according to embodiments of the invention, a diffusion layer in which oxygen is embedded in atomic form in a metal lattice of the covering layer. The component is in particular a blade.

The component thus has improved wear properties and an improved abrasion behavior. The diffusion layer as surface of the component withstands, in particular, droplet impact for longer than the untreated covering layer.

### BRIEF DESCRIPTION

Some of the embodiments will be described in detail, with reference to the following figures, wherein like designations denote like members, wherein:

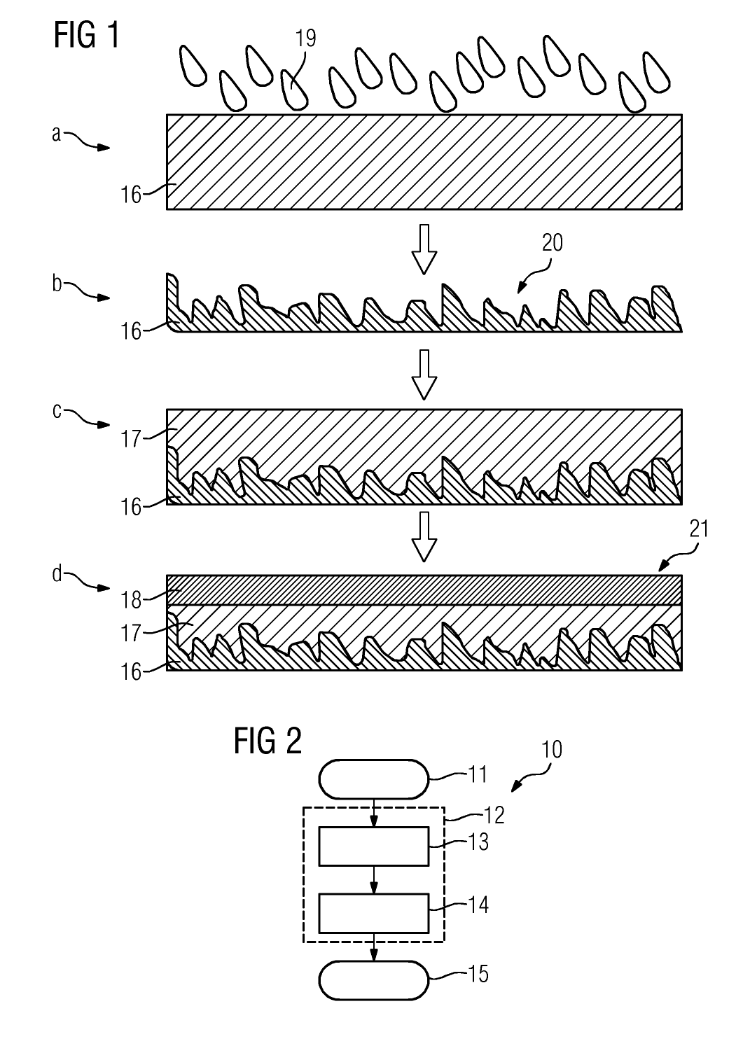

FIG. 1 depicts an illustration of the coating process and the component according to an embodiment of the invention; and

FIG. 2 depicts a flowchart of the coating process according to an embodiment of the invention.

### DETAILED DESCRIPTION

FIG. 1 shows an illustration of the coating process 10 according to embodiments of the invention. A base material 16 is depicted therein in various stages a), b), c) and d).

The base material 16 is, in particular, part of a low-pressure blade of a steam turbine.

In stage a), the base material 16 is in operation and is subjected to operational influences, for example droplet impact and abrasive wear. Water droplets 19 which impinge on the base material 16 are shown illustratively here. Mechanical notches can be formed here by rutting of the material.

In stage b), the base material 16 has been eroded as a result of the operational influences. Droplet impact erosion 20, which in the case of low-pressure blades of steam turbines represents a specific form of notch formation, is depicted by way of example. In the case of steam turbines, mist droplets are formed in the stream of steam and these are captured by guide blades, accumulate there and at the exit edges thereof break off as water droplets 19. As a result of high circumferential velocities and prevailing flows at the rotor blades, these water droplets 19 lead to surface rutting due to droplet impact erosion 20.

In stage c), the eroded base material 16 is provided with a covering layer 17. The eroded material is thereby filled. The filling of the material can, for example, have been carried out by means of deposition soldering. This method is known in the prior art.

Stage d) shows the base material 16 after a repair by means of the coating process 10 according to embodiments of the invention and an illustrative embodiment of the component 21 according to the invention.

The base material 16 has been coated with a covering layer 17. The covering layer fills the eroded regions. In addition, the covering layer 17 comprises a diffusion layer 18. In the diffusion layer 18, atomic oxygen is embedded in the metal lattice of the covering layer. The diffusion layer 18 forms the surface of the component 21. The base material 16 is, in particular, TiA16V4. The covering layer 17 is, for example, formed by Ti braze. The diffusion layer has, in particular, a layer thickness of more than 80 μm, in particular in the range from 0.5 mm to 2 mm. The component 21 is a steam turbine part and in particular a low-pressure blade.

One possible way of producing the component 21 of embodiments of the invention is the coating process 10 of the invention. The coating process 10 is depicted in an illustrative variant in a flow diagram in FIG. 2 from a start 11 to an end 15.

The coating process 10 of embodiments of the invention represents a combination of a soldering process and an oxygen diffusion process. Here, the covering layer 17 is produced from a solder on a surface of the base material 16.

In particular, a titanium alloy such as TiA16V4, in particular, is used as base material 16 and a titanium-based solder, for example Ti braze, is used as solder. It is possible to mix the solder with a material which consists of the same material as the base material 16. The mixing ratio here is in the range from 30 percent by mass to 70 percent by mass.

The solder is, in particular, used in powder form. For this purpose, the solder powder can have been applied to a support layer. The support layer and the solder powder together form a ribbon. The ribbon is, in particular, adhesively bonded onto the surface of the base material 16.

The solder which has been positioned on the surface of the base material 16 is subjected to a heat treatment 12. The heat treatment takes place, for example, in a furnace. Firstly, the solder is heated to its melting point by a heating step 13. Oxygen is subsequently introduced into the molten solder by a diffusion step 14. The diffusion step 14 takes, in particular, 0.5 hours. During the diffusion step 14, an atmosphere, a temperature and a pressure which cause oxygen to diffuse into the solder are produced.

After a cooling process, the solder forms the covering layer 17 which is firmly bound to the base material 16. The region of the solder into which the oxygen has diffused forms the diffusion layer 17.

Although the invention has been illustrated and described in detail by the preferred working example, the invention is not restricted to the examples disclosed and other variations can be derived therefrom by a person skilled in the art, without going outside the scope of protection of the invention.

1. A coating process for applying a covering layer onto a base material, comprising:
heating a solder positioned on a surface of the base material in a heat treatment until the solder is molten to join the solder to the base material, wherein oxygen is diffused into the molten solder to form a diffusion layer in the covering layer.

2. The coating process as claimed in claim 1, wherein a titanium alloy is used as the base material.

3. The coating process as claimed in claim 2, wherein a titanium-based solder is used as the solder.

4. The coating process as claimed claim 1, wherein the solder is mixed with an additional base material which consists of the same material as the base material.

5. The coating process as claimed in claim 4, wherein the additional base material is present in a proportion by mass of from 30% to 70% in the solder.

6. The coating process as claimed in claim 1, wherein the solder is used in a pulverulent form.

7. The coating process as claimed in claim 6, wherein a ribbon in which the pulverulent solder has been applied to a support layer is used.

8. A component for a steam turbine, comprising:
a base material; and
a covering layer affixed to a surface of the base material, wherein the covering layer has a diffusion layer in which atomic oxygen is embedded in a metal lattice of the covering layer.
